(19) United States
(12) Patent Application Publication
(10) Pub. No.: US 2004/0255292 A1
(43) Pub. Date: Dec. 16, 2004

(54) Delivering multiple installation images and computer-readable installation keys on installation media

(75) Inventor: Mark Benedikt, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/462,929

(22) Filed: Jun. 16, 2003

(51) Int. Cl. G06F 9/445

(52) U.S. Cl. 717/174

(57) ABSTRACT

According to the present invention, a plurality of content installations represented by installation images are stored on a single set of installation media. The set of installation media is comprised of at least one data bearing device. Also written to the installation media is at least one installation key, in a computer-readable format. The at least one installation key corresponds to at least one of the plurality of installation images. The installation key is used by an installation process to install at least one of the plurality of installation images onto a target computer.

### FIELD OF THE INVENTION

The present invention relates to digital content distribution, and in particular, delivering multiple installation images of digital content on a set of installation media.

### BACKGROUND OF THE INVENTION

Typically, content providers deliver content in the form of installable images on a set of installation media, such as CD or DVD disks. Accompanying the installation media is a printed installation key that a user must enter during an installation process, by which content providers attempt to ensure that the installation is an authorized installation, and not pirated. For each installation image to be installed, such as software programs, images, fonts, music, and the like, a content provider places an installation image of the content on a set of installation media dedicated to just that content. The set of installation media may comprise a single disk, or a set of disks upon which the installation image is placed. However, content providers having more than one installable image, must create a corresponding installation media set per each installable image.

One reason for delivering one installable image per set of installation media has been the limited storage capacity of the installation media. Previously, the installation image typically filled all or most of the entire storage capacity of the installation media. Thus, delivering multiple installation images was impractical due to the large number of individual media devices that would be required. However, the capacity of installation media has increased substantially, especially with the advent of optical media, and in particular, DVD disks. With this increased capacity, where previously only one installation image could be practically delivered to a consumer on a single set of installation media, now multiple installation images may be stored on a single installation media set.

Another reason for delivering one installable image per installation media set is related to the installation keys. As previously mentioned, most installation keys are placed on printed material supplied with the installation media, or on an enclosing media case. Delivering multiple installation keys to a user with a single installation media set would create a confusing, and therefore unacceptable, situation for most consumers.

What is lacking in the prior art is a system for delivering multiple installation images and at least one corresponding computer-readable installation key on an installation media. The present invention addresses this and other deficiencies found in the prior art.

### SUMMARY OF THE INVENTION

A computer-readable medium bearing content data for installation onto a computer is presented. The content data includes a plurality of installation images. Each installation image represents an installable content. The content data also includes at least one installation key corresponding to one of the plurality of installation images.

A method for installing content on installation media bearing multiple installation images is presented. At least one installation key is read from the installation media. For each installation key read from the installation media, a corresponding installation image is determined, and the content represented by the corresponding installation image is installed onto the computer using the installation key. Alternatively, for each installation image on the installation media, it is determined whether there is a corresponding installation key on the installation media that may be used to install the content represented by the installation image. If there is a corresponding installation key, the content represented by the installation image is installed onto the computer using that installation key.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary computer system for implementing aspects of the present invention;

FIG. 2 is a pictorial diagram illustrating a system for delivering multiple installation images and at least one computer-readable installation key on a set of installation media, in accordance with the present invention;

FIGS. 3A and 3B are flow diagrams illustrating exemplary routines for installing content from installation media bearing a plurality of installation images and at least one installation key onto a computer, in accordance with the present invention; and

FIG. 4 is a flow diagram illustrating an exemplary method for placing multiple installation images and at least one installation key onto a set of installation media.

### DETAILED DESCRIPTION

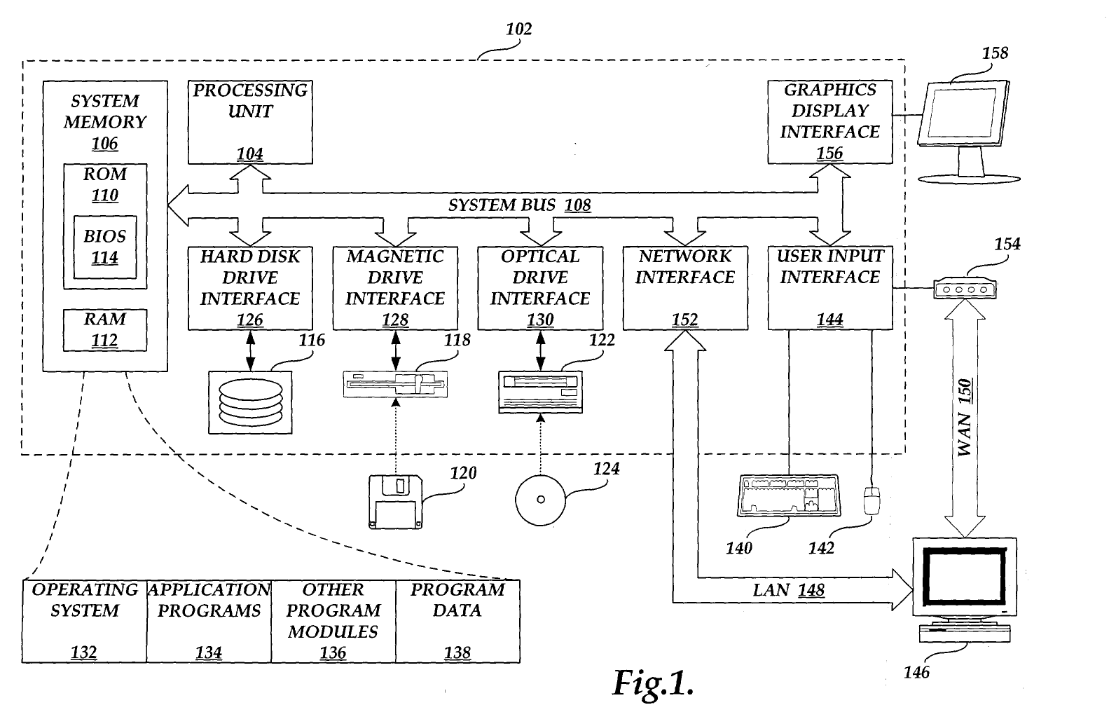

FIG. 1 and the following discussion are intended to provide a brief, general description of a computing system suitable for implementing various features of the invention. While the computing system will be described in the general context of a personal computer usable in a distributed computing environment, where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, personal digital assistants (PDAs), and other devices upon which computer software or other digital content is installed.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc. that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer information between elements within the personal computer 102, such as during startup, is stored in ROM 110. The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, such as magnetic cassettes, flash memory cards, digital video disks, Bernoulli cartridges, ZIP disks, and the like may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB). A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a PDA, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The logical connections depicted in FIG. 1 include a local area network (LAN) 148 and a wide area network (WAN) 150. Such networking environments are commonplace in offices, enterprise-wide computer networks, intranets, and the Internet.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the system.

As previously discussed, as part of delivering software to an end user, a content provider will typically generate a collection of installation files for installing content onto a target computer, such as the personal computer 102 described above in regard to FIG. 1. The collection of installation files is commonly referred to as an installation image. Installation images are usually not in a condition to be immediately used simply by copying the image to the target computer 102. Instead, they typically must be initialized, or customized, by an installation process for use on the target computer. Installation images typically include numerous files for customization to a particular computer's hardware components. Thus, not all data in an installation image is used or transferred to the target computer 102 during the installation process. Language modules and hardware specific device drivers are examples of files which may or may not be used or transferred to the target computer 102 during the installation process. Also typically included on the installation media is the installation program, which when executed, carries out the above-described installation process.

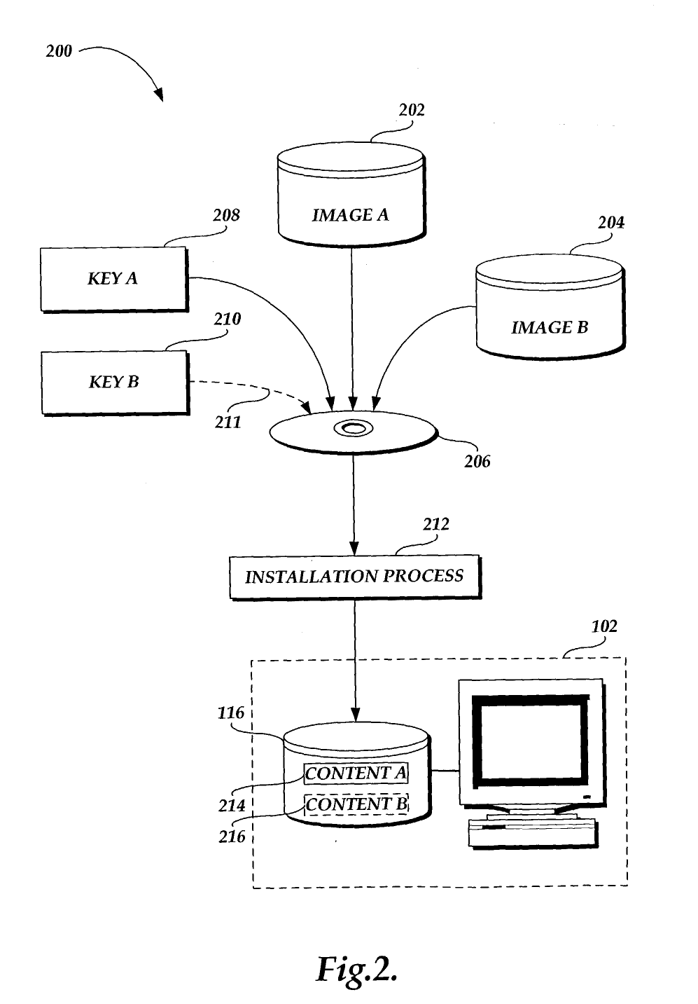

FIG. 2 is a pictorial diagram illustrating an exemplary system 200 for delivering multiple installation images and at least one computer-readable installation key on a set of installation media, in accordance with the present invention. As shown in FIG. 2, this exemplary system 200 includes two installation images, Image A 202 and Image B 204, both delivered on a single set of installation media 206. An installation program (not shown) may also be included on the installation media 206. When executed, the installation program carries out the installation process 212: installing installation images stored on the installation media onto the target computer 102. It should be noted that while only two installation images are shown in FIG. 2, it is for illustration purposes only, and should not be construed as limiting upon the present invention. Those skilled in the art will recognize that more than two installation images may be placed on a single set of installation media.

Corresponding to each installation image is an installation key. In other words, each installation image has a corresponding installation key that may be used to install the content represented by the image onto the target computer 102. For purposes of this discussion, Key A 208 corresponds to Image A 202, and Key B 210 corresponds to Image B 204. Installation keys typically include a unique serial number that is used during the installation process 212 to uniquely identify an installation of the content. In other words, the installation process 212 uses the unique serial number to individualize the content installation on the target computer 102. However, because most installation media is mass-produced on read-only media, and because installation keys are unique, installation keys have not previously been written to the installation media 206. This problem is resolved in co-pending application “System and Method for Individualizing Installation Media,” Attorney Docket No. MSFT-1-20502, U.S. patent application Ser. No.______, and filed ______, which is incorporated herein by reference.

As illustrated in FIG. 2, one installation key, Key A 208, is written to the installation media 206 in a computer-readable format. Other installation keys, corresponding to other installation images on the installation media 206, such as Image B 204, may optionally be placed on the installation media 206, as illustrated by the dashed arrow 211 showing that Key B 210 is optionally written to the installation media. It should be noted that while the present discussion presents a one-to-one correspondence of installation keys to installation images, this is for illustration purposes, and should not be construed as limiting upon the present invention. According to an alternative embodiment, a single installation key may correspond to multiple installation images on a set of installation media 206.

To install the provided content, a user causes the target computer 102 to read the installation media 206. For example, if the installation media is a CD disk, a user inserts the disk into an appropriate drive, such as the optical drive 122 described above in regard to FIG. 1, and an installation process 212 is initiated. Those skilled in the art will readily recognize that the installation process 212, may be initiated automatically upon placing the installation media 206 in a suitable drive. Alternatively, the installation process 206 may be initiated by an explicit user action to do so, such as executing the installation program.

One of the functions of the installation process 206 is to validate an installation key to determine whether a user is authorized to install the content. As discussed in greater detail in co-pending application “System and Method for Individualizing Installation Media,” when a content provider is able to ensure, through the installation key, that content installations are limited to authorized installations, access to multiple installation images is not problematic.

Currently, a user must manually enter an installation key provided with installation media. Assuming the installation key is authentic and the user correctly entered the installation key, the installation process installs the content represented by the installation image onto the user's computer. However, in contrast to the prior art and in accordance with the present invention, at least one installation key, such as Key A 208, is written to the installation media 206. The installation process 212 reads the installation key(s) from the installation media 206, eliminating any user errors associated with manually entering the installation key(s), and further eliminating the confusion related to delivering multiple installation keys with a single set of installation media.

According to the installation key(s) found on the installation media 206, the installation process 212 installs the corresponding content represented by the installation images onto the target computer 102. For example, as Key A 208 is written on the installation media 206, the installation process 212 installs the corresponding content represented by Image A 202 on the hard drive 116 of the target computer 102, as illustrated by Content A 214. Additionally, if Key B 210 is optionally found on the installation media 206, as illustrated by the dashed arrow 211, the installation process 212 could also install the content represented by Image B 204 onto the target computer 102, as illustrated by Content B 216. Content B 216 is shown in a dashed box indicating that it is optionally installed if Key B 210 is written to the installation media 206.

As described above, fewer installation keys may be written to the installation media 206 than installation images written to the installation media. For example, while Image A 202 and Image B 204 are written to the installation media 206, perhaps only Key A 208 is written to the installation media. Thus, assuming that Key A 208 corresponds only to Image A 202 , only the content represented by Image A may be installed onto the target computer 102. However, at some future point, a user may wish to also have the content represented by Image B 204 installed on the target computer 102. Rather than obtaining a new installation media with multiple installation keys, including Key B 210, the user could obtain Key B from the content provider, such as over the Internet or in some other way, and use it to install the additional content from the installation media 206 already in the user's possession. As a further example, a user may subsequently wish to install the content onto an additional computer. If the installation key, such as Key A 208, permits only one authorized installation of the content, a user could obtain additional installation keys from the content provider, as described above, for the additional installation without obtaining additional installation media 206.

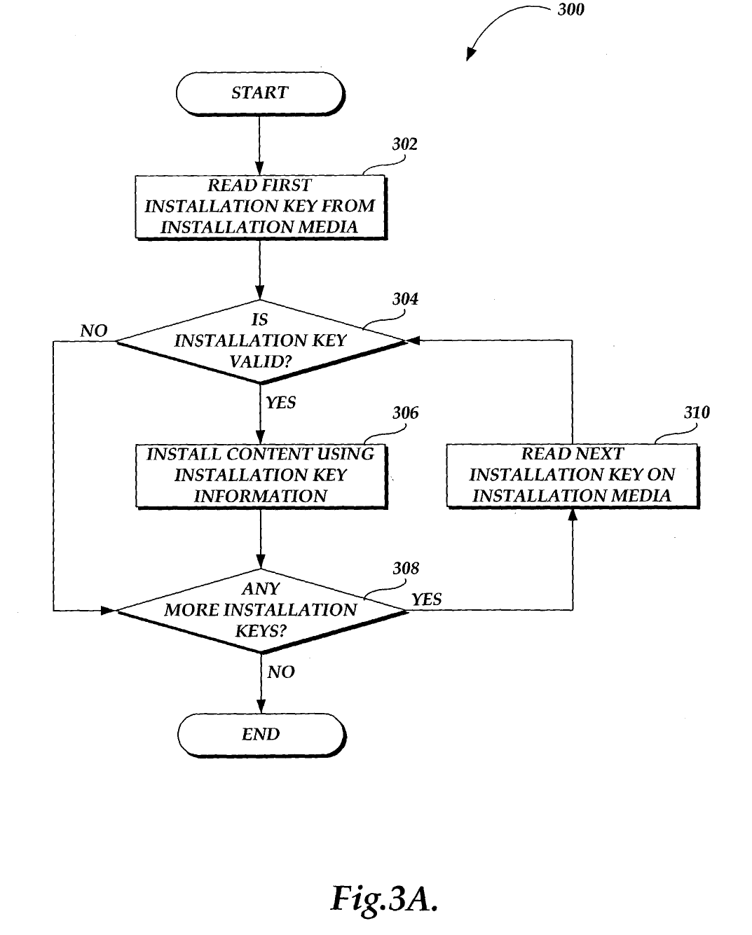

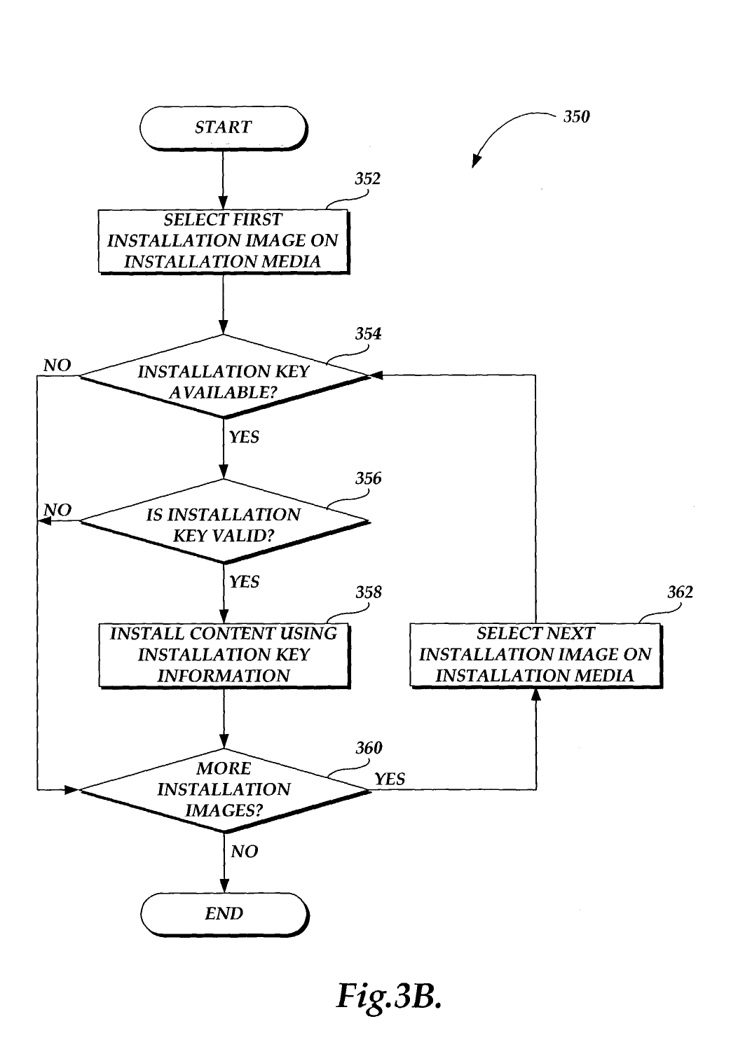

FIG. 3A is a flow diagram illustrating an exemplary routine 300 for installing content from a set of installation media 206 bearing a plurality of installation images and at least one installation key onto a target computer 102, in accordance with aspects of the present invention. Beginning at block 302, a first installation key, such as Key A 208, stored on the installation media 206, is read. At decision block 304, a determination is made as to whether the installation key is valid. A more detailed description of determining whether an installation key is valid is provided in the co-pending application “System and Method for Individualizing Installation Media” previously mentioned. If the installation key is valid, at block 306, the installation process 212 installs the content represented by the installation image corresponding to the installation key onto the target computer 202.

Thereafter, or alternatively if at decision block 304, it is determined that the installation key is not valid, a subsequent determination is made at decision block 308 as to whether there are any additional installation keys on the installation media 206. If there are no additional installation keys on the installation media 206, the exemplary routine 300 terminates. Alternatively, if there are additional installation keys on the installation media 206, at block 310, the next installation key stored on the installation media 206 is read. Returning again to decision block 304, a new determination is made as to whether the newly selected installation key is valid. This process continues until, at block 308, no additional installation keys are found on the installation media 206, whereupon the routine 300 terminates.

FIG. 3B is a flow diagram illustrating an alternative exemplary routine 350 for installing content from a set of installation media 206 bearing a plurality of installation images and at least one installation key onto a target computer 102, in accordance with the present invention. Beginning at block 352, a first installation image, such as Image A 202 shown in FIG. 2, stored on the installation media 206 is selected. At decision block 354, a determination is made as to whether an installation key corresponding to the selected installation image is available on the installation media 206. If a corresponding installation key is available on the installation media 206, at decision block 356, a further determination is made as to whether the corresponding installation key is valid. If the installation key is valid, at block 358, the installation process 212 installs the content represented by the selected installation image using the installation key.

Thereafter, or if at decision block 354 an installation key for the selected installation image is not available on the installation media 206, or further if, at decision block 356, the installation key is not valid, the exemplary routine 350 proceeds to decision block 360. At decision block 360, a determination is made as to whether any other installation images are on the installation media 206. If there are no other installation images on the installation media 206, the exemplary process 350 terminates. Alternatively, if there are other installation images on the installation media 206, at block 362, the next installation image on the installation media is selected. Thereafter, the process returns to decision block 354 to determine whether a corresponding installation key is also available on the installation media 206. Processing installation images stored on the installation media 206 repeats until, at decision block 360, no more installation images are found on the installation media 206.

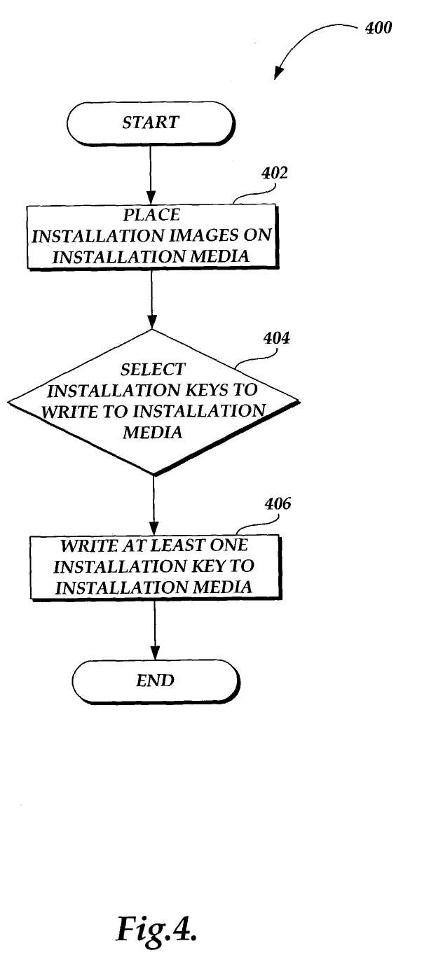

While some aspects of the invention, described above, are directed at installing content onto a target computer, other aspects of the invention are directed at creating the installation media set comprising a plurality of installation images and at least one installation key. FIG. 4 is a flow diagram illustrating an exemplary routine 400 for placing multiple installation images and at least one installation key onto an installation media. Beginning at block 402, a plurality of installation images are placed on a set of installation media 206. As previously discussed, because of the increased capacity of installation media, and in particular optical media such as CDs or DVDs, a content provider may provide numerous installation images on a single installation media set. Placing the installation images onto the installation media is typically carried out well known via mass-production techniques. At decision block 404, a determination is made as to which installation keys corresponding to the plurality of installation images written to the installation media 206 should be placed on the installation media. According to this determination, at block 406, at least one installation key is written to the installation media. Thereafter, the routine 400 terminates.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer-readable medium bearing computer-readable data for installation onto a target computer, the computer-readable data comprising:
a plurality of installation images, each installation image representing installable content; and
at least one installation key corresponding to one of the plurality of installation images, wherein the at least one installation key enables an installation process to install the content represented by the corresponding installation image onto the target computer.

2. The computer-readable medium of claim 1, wherein the computer-readable data further comprises an executable installation module which, when executed, carries out the installation process of installing the content on the target computer.

3. The computer-readable medium of claim 1, wherein an installation image includes a plurality of associated modules.

4. The computer-readable medium of claim 3, wherein the plurality of associated modules includes language modules.

5. The computer-readable medium of claim 3, wherein the plurality of associated modules includes hardware specific modules.

6. The computer-readable medium of claim 1, wherein the computer-readable medium is an optical disk.

7. The computer-readable medium of claim 6, wherein the computer-readable medium is a CD disk.

8. The computer-readable medium of claims 6, wherein the computer-readable medium is a DVD disk.

9. A method for installing content from installation media bearing multiple installation images onto a target computer, comprising:
reading at least one installation key from the installation media; and
for each installation key read from the installation media:
determining a corresponding installation image stored on the installation media; and
installing the content represented by the corresponding installation image onto the target computer using the installation key.

10. A method for installing content from installation media bearing multiple installation images onto a target computer, comprising:
for each installation image on the installation media:
determining whether there is a corresponding installation key on the installation media that may be used to install the content represented by the installation image; and
if there is a corresponding installation key, installing the content represented by the installation image onto the target computer using the corresponding installation key.

11. A method for creating installation media for installing content on a target computer, the method comprising:
placing a plurality of installation images onto installation media, wherein each installation image represents installable content; and
writing at least one installation key corresponding to at least one of the plurality of installation images onto the installation media.
